(19) United States
(12) Patent Application Publication
(10) Pub. No.: US 2025/0055229 A1
(43) Pub. Date: Feb. 13, 2025

(54) SHIELD MEMBER, CONNECTOR WITH SHIELD MEMBER, ELECTRONIC COMPONENT WITH SHIELD, SHIELD, AND SHIELD STRUCTURE

(71) Applicant: IRISO ELECTRONICS CO., LTD., Yokohama-shi, Kanagawa (JP)

(72) Inventors: Hideki Shioda, Yokohama-shi (JP); Yoshihito Ohkuma, Yokohama-shi (JP)

(21) Appl. No.: 18/797,132

(22) Filed: Aug. 7, 2024

(30) Foreign Application Priority Data
Aug. 8, 2023 (JP) 2023-129612

(51) Int. Cl. H01R 13/6581; H01R 13/6594

(52) U.S. Cl. CPC H01R 13/6581; H01R 13/6594

(57) ABSTRACT

A shield member includes a base portion that is not displaced with respect to an attachment object and a movable shield portion that is displaceable with respect to the base portion. The movable shield portion does not have a portion fixed to shield objects.

### CROSS-REFERENCE TO RELATED APPLICATION

This application claims priority under 35 USC 119 from Japanese Patent application No. 2023-129612 filed on Aug. 8, 2023, the disclosure of which is incorporated by reference herein in its entirety.

### BACKGROUND

### Technical Field

The present disclosure relates to a shield member, a connector with a shield member, an electronic component with a shield, a shield, and a shield structure.

### Related Art

Japanese Patent Application Laid-Open (JP-A) Nos. 2021-096933 and 2018-186056 disclose a connector with a shield member.

### SUMMARY

An object to be solved by a first aspect of the disclosure is to suppress generation of a gap in a first direction between a contact target and a shield member or increase of the gap due to variation in a distance in the first direction between an attachment target and the contact target.

An object to be solved a second aspect of the disclosure is to simplify a structure of the shield member.

An object to be solved a third aspect of the disclosure is to realize an inexpensive connector with a shield member.

### (First Aspect)

A shield member according to an aspect 1-1 is a shield member for shielding a shielding target, the shield member including a base portion that does not displace with respect to an attachment target; and a movable shield portion that is displaceable with respect to the base portion, in which the movable shield portion has a contact portion configured to come into contact with a contact target as a result of bringing the contact target and the shield member close to each other in a first direction, the contact portion of the movable shield portion is configured such that a contact pressure is generated in the first direction by the contact with the contact target, and the movable shield portion is configured to be displaced in the first direction when the contact portion is pressed by the contact target in the first direction.

The present aspect relates to a shield member for shielding a shielding target.

In the present aspect, the shield member includes a base portion that does not displace with respect to an attachment target, and a movable shield portion that is displaceable with respect to the base portion.

Therefore, the shielding target can be shielded by the movable shield portion that is displaceable with respect to the attachment target.

In the present aspect, the movable shield portion has a contact portion configured to come into contact with a contact target as a result of bringing the contact target and the shield member close to each other in a first direction. The contact portion of the movable shield portion is configured such that a contact pressure is generated in the first direction by the contact with the contact target. The movable shield portion is configured to be displaced in the first direction when the contact portion is pressed by the contact target in the first direction.

Therefore, it is possible to suppress generation of a gap in the first direction between the contact target and the shield member or increase of the gap due to variation in a distance in the first direction between the attachment target and the contact target.

The attachment target means an target to which the shield member is to be attached. In the embodiments described later, the attachment target is a substrate, but the attachment target of the present aspect is not limited thereto. In the embodiments described later, the shield member is directly attached to the attachment target (substrate) at the connecting portion. However, a case in which the shield member is indirectly attached to the attachment target via a member other than the shield member (for example, a housing of the connector) is also included in a case in which “the shield member is attached to the attachment target”.

The contact target means an target with which the shield member comes into contact. In the embodiments described later, the contact target is a mating substrate (second substrate) or a mating shield member (second shield member), but the contact target of the present aspect is not limited thereto. The contact target of the present aspect may be, for example, another component attached to the mating substrate, such as a housing included in the mating connector or a ground terminal included in the mating connector.

In the embodiments described later, the contact portion of the movable shield portion comes into contact with the contact target, whereby the shield member and the contact target are electrically connected, but the present aspect is not limited thereto.

In the embodiments described later, the shield member is attached to the attachment target, whereby the shield member and the attachment target are electrically connected, but the present aspect is not limited thereto.

In the embodiments described later, the first direction is a direction perpendicular to a plane of the attachment target, but the first direction of the present aspect is not limited thereto.

In the embodiments described later, the shield member is formed by subjecting a plate material to punching, bending, or the like, but the shield member of the present aspect is not limited thereto.

In the embodiments described later, the movable shield portion does not have a portion that is fixed to the shielding target, but the movable shield portion of the present aspect is not limited thereto.

In the embodiments described later, the movable shield portion is configured to be displaceable only in the first direction with respect to the base portion, but the movable shield portion of the present aspect is not limited thereto. The movable shield portion of the present aspect may also be displaceable in a direction other than the first direction.

In the aspect 1-1, in a shield member according to an aspect 1-2, the contact portion is formed in a convex shape so as to come into point contact with the contact target.

In the present aspect, the contact portion is formed in a convex shape so as to come into point contact with the contact target.

Therefore, it is compatible with a planar contact portion of the contact target.

In the aspect 1-1 or 1-2, in a shield member according to an aspect 1-3, the movable shield portion does not have a portion that is fixed to the shielding target.

In the present aspect, the movable shield portion does not have a portion that is fixed to the shielding target.

Therefore, it is not necessary to provide a structure for being fixed to the shielding target on the movable shield portion. As a result, the structure of the shield member can be simplified.

In the embodiments described later, the movable shield portion does not have a portion that is physically engaged with the shielding target, but the movable shield portion of the present aspect is not limited thereto. The movable shield portion of the present aspect may have a portion that is physically engaged with the shielding target as long as the movable shield portion does not have a portion that is fixed to the shielding target. The case in which the movable shield portion has a portion that is physically engaged with the shielding target is, for example, a case in which the movable shield portion is in slidable contact with the shielding target.

In any one of the aspects 1-1 to 1-3, in a shield member according to an aspect 1-4, the movable shield portion does not have a portion that is physically engaged with the shielding target.

In the present aspect, the movable shield portion does not have a portion that is physically engaged with the shielding target.

Therefore, it is not necessary to provide a structure for physically engaging with the shielding target on the movable shield portion. As a result, the structure of the shield member can be simplified.

In any one of the aspects 1-1 to 1-4, in a shield member according to an aspect 1-5, the shield member does not have a portion that is fixed to the shielding target.

In the present aspect, the shield member does not have a portion that is fixed to the shielding target.

Therefore, it is not necessary to provide a structure for being fixed to the shielding target on the shield member. As a result, the structure of the shield member can be simplified.

When it becomes unnecessary to provide a structure for being fixed to the shielding target on the shield member, it becomes easy to correspond to a plurality of types of shielding targets with one type of shield member. That is, even when a size or a shape of the shielding target is changed, it is easy to shield with the shield member having a same structure.

In any one of the aspects 1-1 to 1-5, in a shield member according to an aspect 1-6, the movable shield portion does not have a portion that is fixed to the shielding target, and the base portion has a portion that is fixed to the shielding target.

In the present aspect, the movable shield portion does not have a portion that is fixed to the shielding target.

Therefore, it is not necessary to provide a structure for being fixed to the shielding target on the movable shield portion.

In the present aspect, the base portion has a portion that is fixed to the shielding target.

Therefore, the shielding target and the shield member can be handled integrally.

In any one of the aspects 1-1 to 1-6, in a shield member according to an aspect 1-7, the base portion includes a fixed shield portion that shields the shielding target.

In the present aspect, the base portion includes a fixed shield portion that shields the shielding target.

Therefore, the shielding target can be shielded by both the fixed shield portion that does not displace with respect to the attachment target and the movable shield portion that is displaceable with respect to the attachment target.

In the embodiments described later, the fixed shield portion has a tubular shape, but the fixed shield portion of the present aspect is not limited thereto. The fixed shield portion of the present aspect may have a certain shape for shielding the shielding target. A certain shape portion for shielding the shielding target is, for example, a plate-like portion that covers the shielding target from a specific direction.

In the aspect 1-7, in a shield member according to an aspect 1-8, the fixed shield portion has a tubular shape, and the movable shield portion has a tubular shape.

In the present aspect, the fixed shield portion has a tubular shape, and the movable shield portion has a tubular shape.

Therefore, high shielding performance can be exhibited.

As will be understood from the embodiments described later, the “tubular shape” in the disclosure includes not only a complete tubular shape having no gap at all in a circumferential direction but also a shape having some gaps at specific positions in the circumferential direction.

In any one of the aspects 1-1 to 1-8, in a shield member according to an aspect 1-9, the movable shield portion includes a plurality of portions that are displaceable independently of each other.

In the present aspect, the movable shield portion includes a plurality of portions that are displaceable independently of each other.

Therefore, even when the contact target is inclined with respect to a predetermined state, a favorable contact state between the movable shield portion and the contact target can be realized.

A connector with a shield member according to an aspect 1-10 is a connector with a shield member that is attachable to an attachment target which is a substrate, and that is connectable to a mating connector in a first direction, the connector including: a shielding target which is a connector, and a shield member, in which the connector includes a terminal, the terminal has a contact portion that comes into contact with a terminal of the mating connector, the shield member includes a base portion that does not displace with respect to the attachment target, and a movable shield portion that is displaceable with respect to the base portion, the movable shield portion has a contact portion configured to come into contact with a contact target as a result of bringing the contact target and the shield member close to each other in a first direction, the contact portion of the movable shield portion is configured such that a contact pressure is generated in the first direction by the contact with the contact target, the contact target is a mating substrate serving as a mating attachment target to which the mating connector is attached, a mating shield member attached to the mating substrate, or another member attached to the mating substrate, and the movable shield portion is configured to be displaced in the first direction when the contact portion is pressed by the contact target in the first direction.

The present aspect relates to a connector with a shield member that is attachable to an attachment target which is a substrate, and that is connectable to a mating connector in a first direction.

In the present aspect, the shield member includes a base portion that does not displace with respect to an attachment target, and a movable shield portion that is displaceable with respect to the base portion.

Therefore, the shielding target can be shielded by the movable shield portion that is displaceable with respect to the attachment target.

In the present aspect, the movable shield portion has a contact portion configured to come into contact with a contact target as a result of bringing the contact target and the shield member close to each other in a first direction. The contact portion of the movable shield portion is configured such that a contact pressure is generated in the first direction by the contact with the contact target. The movable shield portion is configured to be displaced in the first direction when the contact portion is pressed by the contact target in the first direction.

Therefore, it is possible to suppress generation of a gap in the first direction between the contact target and the shield member or increase of the gap due to variation in a distance in the first direction between the attachment target and the contact target.

The “another member attached to the mating substrate” of the present aspect is, for example, a housing included in the mating connector or a ground terminal included in a mating connector, but also includes other members that are neither a mating shield member nor a mating connector.

In the aspect 1-10, in a connector with a shield member according to an aspect 1-11, the contact portion of the movable shield portion is formed in a convex shape so as to come into point contact with the contact target.

In the present aspect, the contact portion of the movable shield portion is formed in a convex shape so as to come into point contact with the contact target.

Therefore, it is compatible with a planar contact portion of the contact target.

In the aspect 1-10 or 1-11, in a connector with a shield member according to an aspect 1-12, the contact portion of the terminal of the connector is configured such that a contact pressure is generated in a direction in a plane perpendicular to the first direction by the contact with the terminal of the mating connector.

It is assumed that the contact portion of the terminal of the connector is configured such that a contact pressure is generated in the first direction by the contact with the terminal of the mating connector. In this case, in order to secure stable electrical connection, it is necessary to continuously press the connector and the mating connector strongly in the first direction, and both substrates (the substrate and the mating substrate) are easily bent together with the pressing of the movable shield portion and the contact target in the first direction.

Therefore, in the present aspect, the contact portion of the terminal of the connector is configured such that a contact pressure is generated in a direction in a plane perpendicular to the first direction by the contact with the terminal of the mating connector.

Therefore, it is possible to suppress bending of both substrates (the substrate and the mating substrate).

In the embodiments described later, a large number of terminals are provided. In this case, the effects described above are particularly important. However, the terminal of the present aspect is not limited thereto.

An electronic component with a shield according to an aspect 1-13 is an electronic component with a shield, the electronic component with a shield including: a shielding target which is the electronic component, and a shield for shielding the shielding target, in which the electronic component includes a first connector attached to a first attachment target and a second connector attached to a second attachment target, and the shield includes a first shield member attached to the first attachment target, the first shield member includes a base portion that does not displace with respect to the first attachment target, and a movable shield portion that is displaceable with respect to the base portion, the movable shield portion has a contact portion configured to come into contact with a contact target which is the second attachment target as a result of bringing the contact target and the first shield member close to each other in a first direction, the contact portion of the movable shield portion is configured such that a contact pressure is generated in the first direction by the contact with the contact target, and the movable shield portion is configured to be displaced in the first direction when the contact portion is pressed by the contact target in the first direction.

An electronic component with a shield according to an aspect 1-14 is an electronic component with a shield, the electronic component with a shield including: a shielding target which is the electronic component, and a shield for shielding the shielding target, in which the electronic component includes a first connector attached to a first attachment target and a second connector attached to a second attachment target, the shield includes a first shield member attached to the first attachment target and a second shield member attached to the second attachment target, the first shield member includes a base portion that does not displace with respect to the first attachment target, and a movable shield portion that is displaceable with respect to the base portion, the movable shield portion has a contact portion configured to come into contact with a contact target which is the second shield member as a result of bringing the contact target and the first shield member close to each other in a first direction, the contact portion of the movable shield portion is configured such that a contact pressure is generated in the first direction by the contact with the contact target, and the movable shield portion is configured to be displaced in the first direction when the contact portion is pressed by the contact target in the first direction.

### (Second Aspect)

A shield member according to an aspect 2-1 is a shield member for shielding a shielding target, the shield member including: a base portion that does not displace with respect to an attachment target; and a movable shield portion that is displaceable with respect to the base portion, in which the movable shield portion does not have a portion that is fixed to the shielding target.

The present aspect relates to a shield member for shielding a shielding target.

In the present aspect, the shield member includes a base portion that does not displace with respect to an attachment target, and a movable shield portion that is displaceable with respect to the base portion.

Therefore, the shielding target can be shielded by the movable shield portion that is displaceable with respect to the attachment target.

In the present aspect, the movable shield portion does not have a portion that is fixed to the shielding target.

Therefore, it is not necessary to provide a structure for being fixed to the shielding target on the movable shield portion. As a result, the structure of the shield member can be simplified.

The attachment target means an target to which the shield member is to be attached. In the embodiments described later, the attachment target is a substrate, but the attachment target of the present aspect is not limited thereto.

In the embodiments described later, the shield member is attached to the attachment target, whereby the shield member and the attachment target are electrically connected, but the present aspect is not limited thereto.

In the embodiments described later, the first direction is a direction perpendicular to a plane of the attachment target, but the first direction of the present aspect is not limited thereto.

In the embodiments described later, the shield member is formed by subjecting a plate material to punching, bending, or the like, but the shield member of the present aspect is not limited thereto.

In the embodiments described later, the movable shield portion has a contact portion configured to come into contact with the contact target, the contact portion is configured such that a contact pressure is generated in the first direction by the contact with the contact target, and the movable shield portion is configured to be displaced in the first direction when the contact portion is pressed by the contact target in the first direction. However, the present aspect is not limited thereto. For example, the movable shield portion of the present aspect is not necessarily displaceable in the first direction. In this case, the movable shield portion may be displaceable in any direction in a plane perpendicular to the first direction, or may be displaceable only in a predetermined direction in a plane perpendicular to the first direction.

In the aspect 2-1, in a shield member according to an aspect 2-2, the movable shield portion does not have a portion that is physically engaged with the shielding target.

In the present aspect, the movable shield portion does not have a portion that is physically engaged with the shielding target.

Therefore, it is not necessary to provide a structure for physically engaging with the shielding target on the movable shield portion. As a result, the structure of the shield member can be simplified.

In the aspect 2-1 or 2-2, in a shield member according to an aspect 2-3, the base portion does not have a portion that is fixed to the shielding target.

In the present aspect, the base portion does not have a portion that is fixed to the shielding target.

Therefore, it is not necessary to provide a structure for being fixed to the shielding target on the base portion.

In any one of the aspects 2-1 to 2-3, in a shield member according to an aspect 2-4, the shield member does not have a portion that is fixed to the shielding target.

In the present aspect, the shield member does not have a portion that is fixed to the shielding target.

Therefore, it is not necessary to provide a structure for being fixed to the shielding target on the shield.

In the aspect 2-1 or 2-2, in a shield member according to an aspect 2-5, the base portion has a portion that is fixed to the shielding target.

In the present aspect, the base portion has a portion that is fixed to the shielding target.

Therefore, the shield and the shielding target can be handled integrally.

In any one of the aspects 2-1 to 2-5, in a shield member according to an aspect 2-6, the base portion includes a fixed shield portion that shields the shielding target.

In the present aspect, the base portion includes a fixed shield portion that shields the shielding target.

Therefore, the shielding target can be shielded by both the fixed shield portion that does not displace with respect to the attachment target and the movable shield portion that is displaceable with respect to the attachment target.

In the aspect 2-6, in a shield member according to an aspect 2-7, the fixed shield portion has a tubular shape, and the movable shield portion has a tubular shape.

In the present aspect, the fixed shield portion has a tubular shape, and the movable shield portion has a tubular shape.

Therefore, high shielding performance can be exhibited.

In the aspect 2-7, in a shield member according to an aspect 2-8, a part of either one of the fixed shield portion or the movable shield portion is disposed inside the other.

In the present aspect, a part of either one of the fixed shield portion or the movable shield portion is disposed inside the other.

Therefore, it is possible to suppress generation of a gap (gap in an axial direction of a cylinder) between the tubular fixed shield portion and the tubular movable shield portion.

A connector with a shield member according to an aspect 2-9 is a connector with a shield member that is attachable to an attachment target which is a substrate, and that is connectable to a mating connector in a first direction, the connector including: a shielding target which is a connector, and a shield member, in which the connector includes a movable housing that is displaceable with respect to the attachment target, the shield member includes a base portion that does not displace with respect to the attachment target, and a movable shield portion that is displaceable with respect to the base portion, and the movable shield portion does not have a portion that is fixed to the shielding target.

The present aspect relates to a connector with a shield member that is attachable to an attachment target which is a substrate, and that is connectable to a mating connector in a first direction.

In the present aspect, the connector with a shield member includes a shielding target which is a connector, and a shield member.

The shield member includes a base portion that does not displace with respect to an attachment target and a movable shield portion that is displaceable with respect to the base portion.

Therefore, the shielding target can be shielded by the movable shield portion that is displaceable with respect to the attachment target.

In the present aspect, the connector includes a movable housing that is displaceable with respect to the attachment target, but the movable shield portion does not have a portion that is fixed to the shielding target.

Therefore, for example, as compared with an aspect in which the movable shield portion is fixed to the movable housing of the connector, it is not necessary to provide a structure for being fixed to the movable housing on the movable shield portion. As a result, the structure of the shield member can be simplified.

In the embodiments described later, the movable housing is displaceable in any direction of an X direction, a Y direction, a Z direction, and directions oblique to these directions, but the movable housing of the present aspect is not limited thereto. For example, the movable housing of the present aspect is not necessarily displaceable in the Z direction. In this case, the movable shield portion may be displaceable in any direction in a plane perpendicular to the Z direction, or may be displaceable only in a predetermined direction in a plane perpendicular to the Z direction. Here, the Z direction is, for example, a connection direction with the mating connector.

In the aspect 2-9, in a connector with a shield member according to an aspect 2-10, the movable shield portion does not have a portion that is physically engaged with the shielding target.

In the present aspect, the movable shield portion does not have a portion that is physically engaged with the shielding target.

Therefore, it is not necessary to provide a structure for physically engaging with the shielding target on the movable shield portion. As a result, the structure of the shield member can be simplified.

In the aspect 2-9 or 2-10, in a connector with a shield member according to an aspect 2-11, the base portion has a portion that is fixed to the shielding target.

In the present aspect, the base portion has a portion that is fixed to the shielding target.

Therefore, the shielding target and the shield member can be handled integrally.

### (Third Aspect)

A connector group with a shield member according to an aspect 3-1 includes a connector group including a plurality of types of connectors; and a shield member configured to accommodate any connector selected from the connector group.

Conventionally, in a connector with a shield member including a shield member and a connector, the shield member is not compatible (see, for example, Japanese Patent Application Laid-Open (JP-A) No. 2018-186056). Therefore, it is necessary to design the shield member for each type of connector.

In the present aspect, the connector group with a shield member includes a connector group and a shield member. The connector group includes a plurality of types of connectors. The shield member is configured to accommodate any connector selected from the connector group.

Therefore, it is not necessary to design the shield member for each type of connector. As a result, an inexpensive connector with a shield member can be realized.

In the aspect 3-1, a connector group with a shield member according to an aspect 3-2 includes another connector group including a plurality of types of connectors; and another shield member configured to accommodate any connector selected from the another connector group.

In the aspect 3-1 or 3-2, in a connector group with a shield member according to an aspect 3-3, the shield member does not have a portion that is fixed to the connector.

Meanwhile, in a case in which the shield member has a portion to be fixed to the connector, it is necessary to provide a common fixing portion (a portion to fix the shield member) in all the connectors belonging to the connector group.

Therefore, in the present aspect, the shield member does not have a portion that is fixed to the connector.

Therefore, this eliminates the need for the above, and it is possible to realize a more inexpensive connector with a shield member.

In any one of the aspects 3-1 to 3-3, in a connector group with a shield member according to an aspect 3-4, the shield member does not have a portion that is fixed to the connector.

According to the present aspect, the connector and the shield can be handled integrally. As a result, in a method (attachment method) of producing an attachment structure of the connector with a shield member, a step of disposing the connector with a shield member on the attachment target is simplified.

In any one of the aspects 3-1 to 3-4, in a connector group with a shield member according to an aspect 3-5, the shield member includes a base portion that does not displace with respect to an attachment target, and a movable shield portion that is displaceable with respect to the base portion.

In any one of the aspects 3-1 to 3-5, in a connector group with a shield member according to an aspect 3-6, the connector group includes a connector including a movable housing.

In any one of the aspects 3-1 to 3-5, in a connector group with a shield member according to an aspect 3-7, the shield member does not have a portion that is fixed to the connector, and the connector group includes a connector including a movable housing.

In any one of the aspects 3-1 to 3-5, in a connector group with a shield member according to an aspect 3-8, the shield member includes a base portion that does not displace with respect to an attachment target, and a movable shield portion that is displaceable with respect to the base portion, the base portion includes a portion that is fixed to the connector, the movable shield portion does not have a portion that is fixed to the connector, and the connector group includes a connector including a movable housing.

In any one of the aspects 3-1 to 3-5, in a connector group with a shield member according to an aspect 3-9, the shield member includes a base portion that does not displace with respect to an attachment target, and a movable shield portion that is displaceable with respect to the base portion, the shield member does not have a portion that is fixed to the connector, and the connector group includes a connector including a movable housing.

The “connector including a movable housing” includes not only a connector in which the movable housing is in a floating state by a terminal but also a connector in which the movable housing is not in a floating state. The movable housing means a housing configured to be displaceable with respect to the attachment target of the connector.

A method of selling a connector with a shield member according to an aspect 3-10 includes presenting the connector group with a shield member according any one of the aspects 3-1 to 3-9.

The present aspect relates to a method of selling a connector with a shield member.

In the present aspect, the method of selling the connector with a shield member is performed by presenting the connector group with a shield member according to the aspect 3-1 or 3-2.

Therefore, the connector with a shield member can be sold at low cost.

A method of producing an attachment structure of a connector with a shield member according to an aspect 3-11 (attachment method of a connector with a shield member) includes a step of selecting and preparing one connector from a connector group including a plurality of types of connectors; a step of preparing a shield member configured to accommodate any connector selected from the connector group; and a step of disposing the one connector and the shield member on an attachment target such that the shield member accommodates the one connector.

According to the present aspect, since the shield member to be prepared is configured to accommodate any connector selected from the connector group, the step of preparing the shield member is simplified.

A method of producing an attachment structure of a connector with a shield member according to an aspect 3-12 (attachment method of a connector with a shield member) includes a step of selecting one connector; a step of preparing a shield member configured to accommodate any connector belonging to a connector group to which the selected one connector belongs; and a step of disposing the one connector and the shield member on an attachment target such that the one connector is accommodated in the shield member.

The “attachment structure of the connector with a shield member” means a structure in which the connector with a shield member is attached to an attachment target.

A shield member according to an aspect 3-13 is a shield member configured to accommodate any connector selected from the connector group including a plurality of types of connectors.

A connector with a shield member according to an aspect 3-14 includes one connector selected from a connector group including a plurality of types of connectors; and a shield member configured to accommodate any connector selected from the connector group.

### BRIEF DESCRIPTION OF THE DRAWINGS

FIG. 1 is a perspective view illustrating a shield structure according to a first embodiment;

FIG. 2 is a cross-sectional view illustrating the shield structure according to the first embodiment;

FIG. 3 is a cross-sectional view illustrating the shield structure (connected state) according to the first embodiment;

FIG. 4 is another cross-sectional view illustrating the shield structure according to the first embodiment;

FIG. 5 is an exploded perspective view of a pair of connectors including a floating connector;

FIG. 6 is a perspective view illustrating a first shield member according to the first embodiment;

FIG. 7 is a cross-sectional perspective view illustrating the first shield member according to the first embodiment;

FIG. 8 is a perspective view illustrating a shield structure according to a second embodiment;

FIG. 9 is a perspective view illustrating a first shield member and a second shield member according to a second embodiment;

FIG. 10 is a cross-sectional perspective view illustrating the first shield member and the second shield member according to the second embodiment;

FIG. 11 is a plan view illustrating a second attachment target, a second connector, and a second shield member;

FIG. 12 is a perspective view illustrating a first modification of the shield structure according to the second embodiment;

FIG. 13 is a perspective view illustrating a first shield member and a second shield member of the first modification;

FIG. 14 is a perspective view illustrating a second modification of a shield structure according to the second embodiment;

FIGS. 15A and 15B are perspective views illustrating states in which different types of connectors are accommodated in a same type of shield member;

FIGS. 16A and 16B are perspective views illustrating states in which the different types of the connectors are accommodated in the same type of the shield member as viewed from another direction; and

FIG. 17 is a view illustrating a state in which a connector with a shield member in a state in which a cap is attached is attached to an attachment target.

### DETAILED DESCRIPTION OF THE INVENTION

Hereinafter, preferred embodiments of a shield member according to the disclosure, a shield structure including the shield member, and the like will be described.

In some cases, a +X direction of an arrow indicated in each drawing may be described as one side in a width direction, a +Y direction of an arrow as one side in a front-rear direction, and a +Z direction of an arrow as an upper side in an up-down direction. However, a posture of the shield member or the like in a use state is not limited.

### First Embodiment

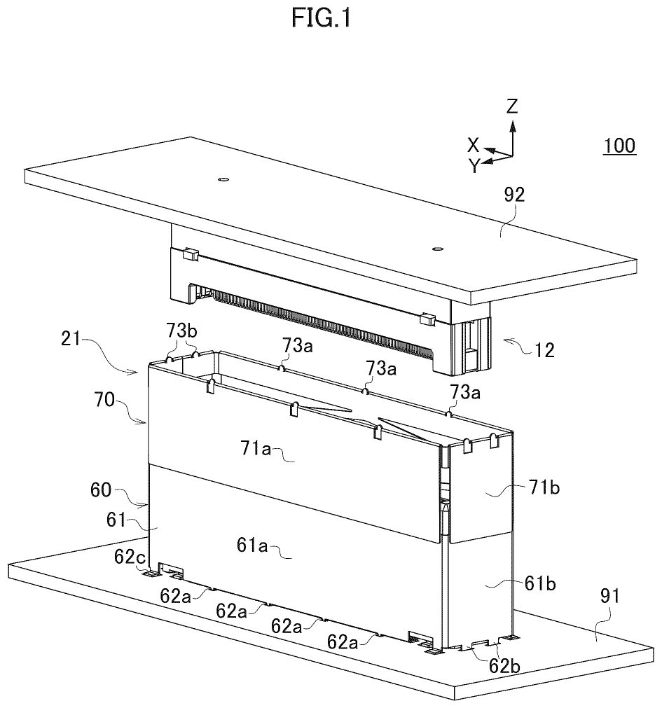

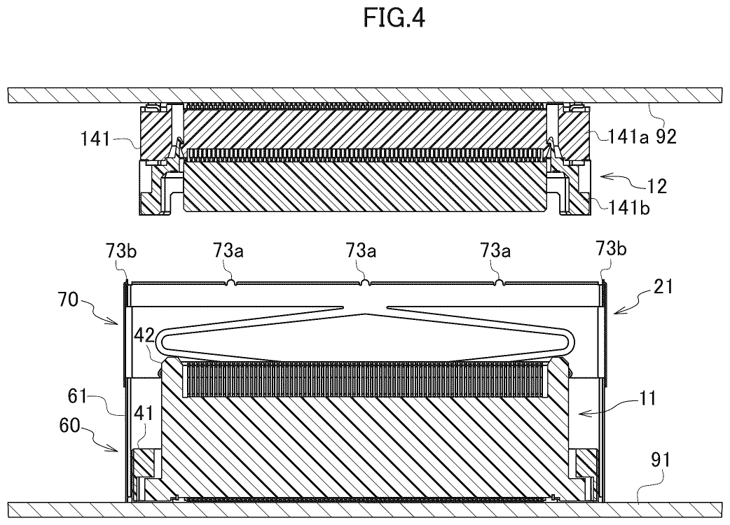

FIGS. 1 to 7 illustrate a shield structure 100 and the like according to a first embodiment.

The shield structure 100 includes attachment targets 91 and 92, electronic components 11 and 12, and a shield 21.

In the shield structure 100, the electronic components 11 and 12 as “shielding targets” are shielded by the shield 21. The electronic components 11 and 12 and the shield 21 are attached to the attachment targets 91 and 92.

The attachment targets 91 and 92 include a first attachment target 91 and a second attachment target 92.

The first attachment target 91 is a first substrate 91, and the second attachment target 92 is a second substrate 92. The first substrate 91 and the second substrate 92 are disposed to face each other with a thickness direction oriented in the same direction (Z direction).

Hereinafter, the first substrate 91 may be simply referred to as a substrate 91, and the second substrate 92 may be referred to as a mating substrate 92.

The electronic components 11 and 12 are a pair of connectors 11 and 12 including a first connector 11 and a second connector 12.

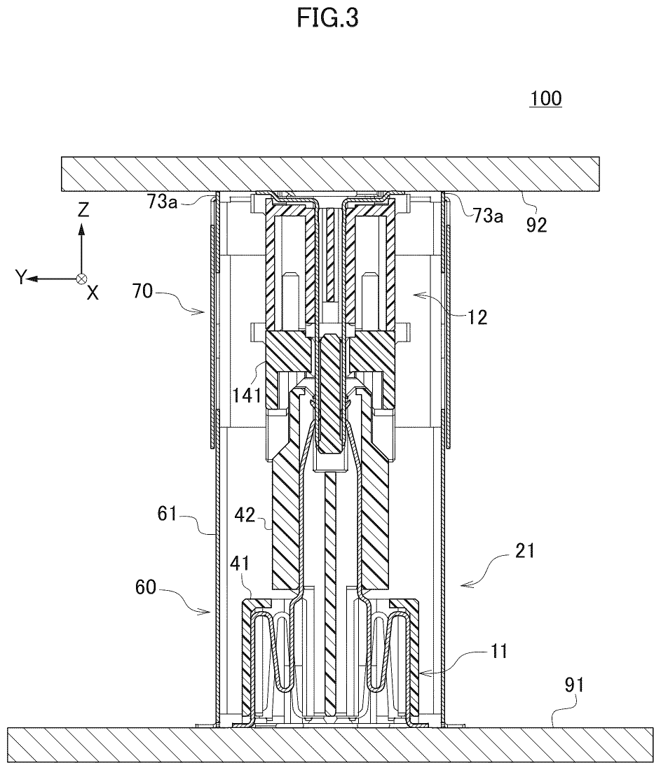

The first connector 11 is attached to the first attachment target 91, and the second connector 12 is attached to the second attachment target 92. When the first connector 11 and the second connector 12 are connected to each other, the first substrate 91 and the second substrate 92 are electrically connected to each other (see FIG. 3).

Hereinafter, the first connector 11 may be simply referred to as a connector 11, and the second connector 12 may be referred to as a mating connector 12.

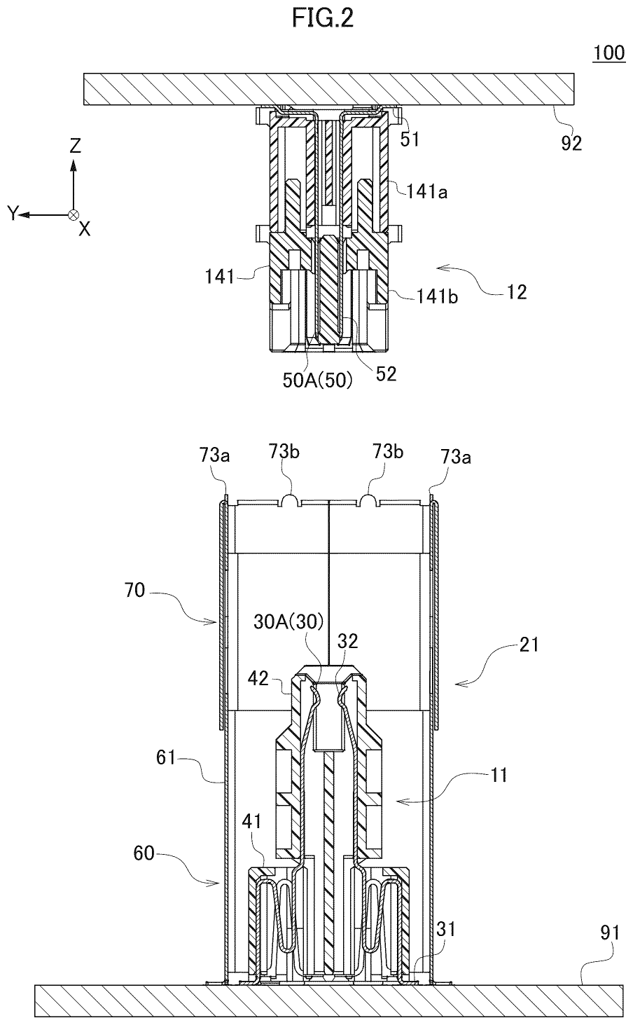

As illustrated in FIG. 2, the first connector 11 is a floating connector.

The first connector 11 includes at least one first terminal 30 and housings 41 and 42 that hold the at least one first terminal 30. The housings 41 and 42 include a fixed housing 41 that is fixed to the first attachment target 91 and a movable housing 42 that is displaceable with respect to the fixed housing 41. The movable housing 42 is displaceable in any direction of the X direction, the Y direction, the Z direction, and directions oblique to these directions.

The first terminal 30 has a connecting portion 31 connected to the first attachment target 91 by soldering, and a contact portion 32 that comes into contact with a terminal 50 of the second connector 12. The first terminal 30 is held by the fixed housing 41 and held by the movable housing 42. In the first terminal 30, an elastically deformable portion is formed between a portion held by the fixed housing 41 and a portion held by the movable housing 42. This allows displacement of the movable housing 42.

The second connector 12 is a connector that is not a floating connector.

The second connector 12 includes at least one second terminal 50 and a housing 141 that holds the at least one second terminal 50. The housing 141 includes a fixed housing 141 that is fixed to the second attachment target 92 and does not include a movable housing that is displaceable with respect to the second attachment target 92.

The second terminal 50 has a connecting portion 51 connected to the second attachment target 92 by soldering, and a contact portion 52 that comes into contact with the first terminal 30.

In the example illustrated in the drawing, the fixed housing 141 includes two molded products 141a and 141b molded separately from each other (see FIG. 2).

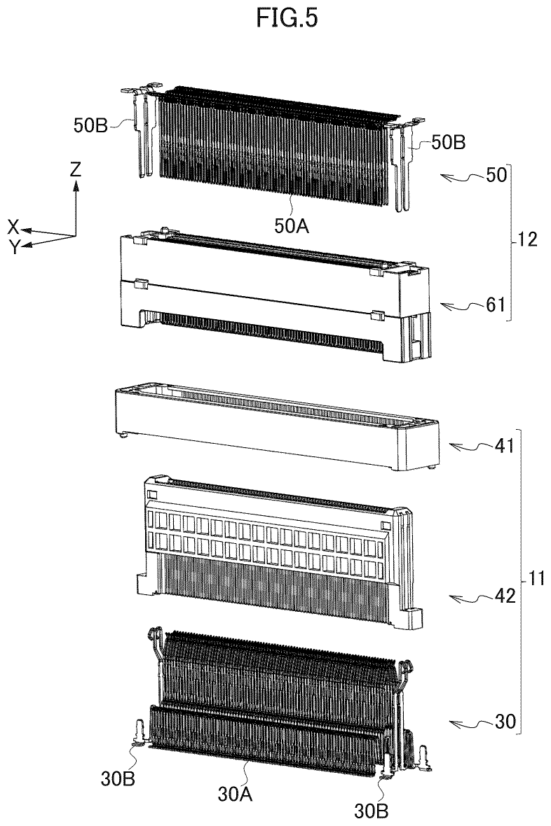

FIG. 5 is an exploded perspective view of the first connector 11 and the second connector 12.

At least one first terminal 30 includes a plurality of first signal terminals 30A. The plurality of first signal terminals 30A are configured by arranging a large number of pairs of first signal terminals 30A in the front-rear direction.

At least one second terminal 50 includes a plurality of second signal terminals 50A. The plurality of second signal terminals 50A are configured by arranging a large number of pairs of second signal terminals 50A in the front-rear direction.

The contact portion 32 of the pair of first signal terminals 30A comes into contact with the contact portion 52 of the pair of second signal terminals 50A so as to sandwich the contact portion 52 from the outer side in the width direction (See FIGS. 2 and 3).

The contact pressure generated by the contact between the contact portion 32 of the first signal terminal 30A and the contact portion 52 of the second signal terminal 50A is generated in a direction in a plane (XY plane) perpendicular to the direction (Z direction) in which the first attachment target 91 and the second attachment target 92 face each other.

The at least one first terminal 30 includes a plurality of first power supply terminals 30B.

The at least one second terminal 50 includes a plurality of second power supply terminals 50B.

The plurality of first power supply terminals 30B are disposed in a region on one side in the front-rear direction and a region on the other side in the front-rear direction with respect to a region where the plurality of first signal terminals 30A are disposed. The same applies to the plurality of second power supply terminals 50B.

As can be seen from FIG. 5 and the like, the contact pressure generated by the contact between the first power supply terminal 30B and the second power supply terminals 50B is generated in a direction in a plane (XY plane) perpendicular to the direction (Z direction) in which the first attachment target 91 and the second attachment target 92 face each other.

### (Shield 21)

The shield 21 includes only a first shield member 21.

Specifically, the first shield member 21 is formed by subjecting a conductive plate material to punching, bending, or the like.

The first shield member 21 has a substantially symmetrical structure in both the front-rear direction and the width direction.

The first shield member 21 has a tubular shape (specifically, a quadrangular tubular shape). The first shield member 21 accommodates the first connector 11 and the second connector 12 therein (see FIG. 3).

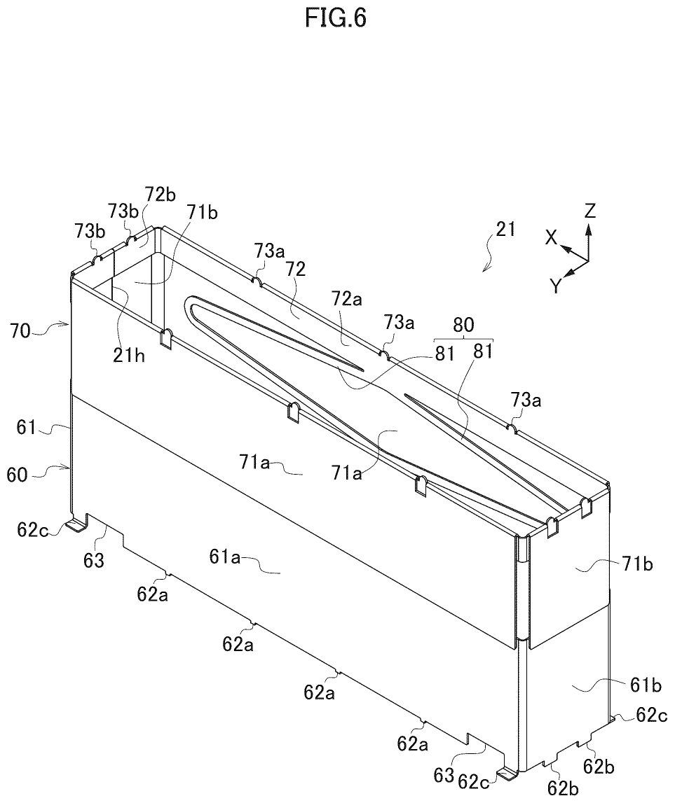

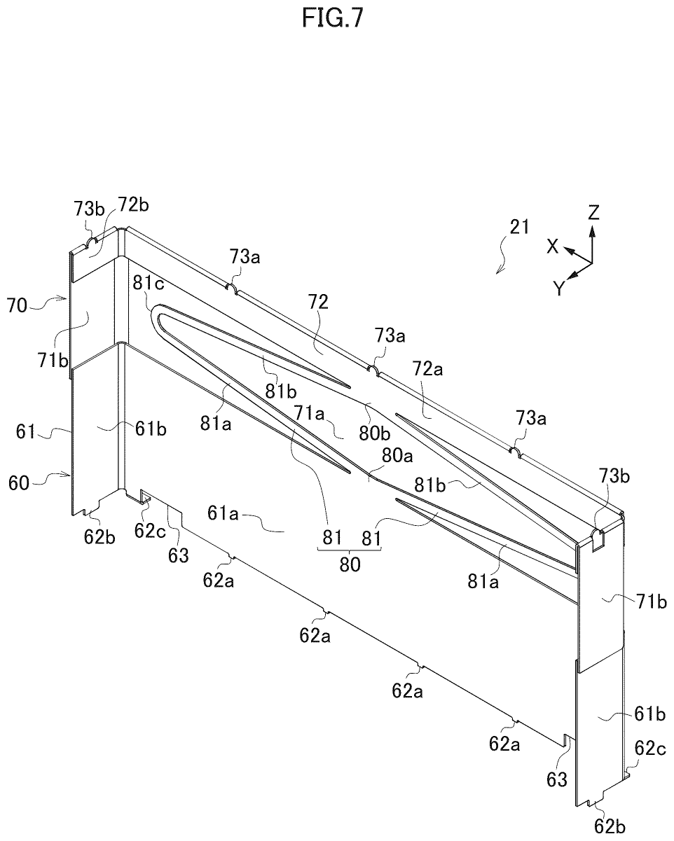

As illustrated in FIGS. 6 and 7, the first shield member 21 has a base portion 60, a movable shield portion 70, and at least one elastic support portion 80.

The base portion 60 is configured not to be displaced with respect to the first substrate 91.

The movable shield portion 70 is configured to be displaceable with respect to the base portion 60.

The at least one elastic support portion 80 elastically supports the movable shield portion 70.

### (Base Portion 60)

The base portion 60 includes a fixed shield portion 61.

The fixed shield portion 61 has a tubular shape (specifically, a quadrangular tubular shape).

The fixed shield portion 61 includes a pair of first plate portions 61a and a pair of second plate portions 61b.

The pair of first plate portions 61a face each other in the width direction. Specifically, each of the first plate portions 61a has a flat plate shape with a plate thickness direction oriented in the width direction.

The pair of second plate portions 61b face each other in the front-rear direction. Specifically, each of the second plate portions 61b has a flat plate shape with the plate thickness direction oriented in the front-rear direction.

The base portion 60 includes a plurality of connecting portions 62a, 62b, and 62c.

Each of the plurality of connecting portions 62a, 62b, and 62c is bonded to a pad (not illustrated) formed on an upper surface of the first substrate 91 by soldering. As a result, the first shield member 21 is attached to the first substrate 91, and the first shield member 21 and the first substrate 91 are electrically connected.

The plurality of connecting portions 62a, 62b, and 62c include a plurality of first connecting portions 62a protruding from the first plate portion 61a.

Each of the first connecting portions 62a has a shape protruding downward with respect to a lower edge of the first plate portion 61a. A plurality of (four) first connecting portions 62a are formed for each of the first plate portions 61a.

The plurality of connecting portions 62a, 62b, and 62c include a plurality of second connecting portions 62b protruding from the second plate portion 61b.

Each of the second connecting portions 62b has a shape protruding downward with respect to a lower edge of the second plate portion 61b. A plurality of (two) second connecting portions 62b are formed for each of the second plate portions 61b.

A plate width dimension (dimension in the width direction) of the second connecting portion 62b is larger than a plate width dimension (dimension in the front-rear direction) of the first connecting portion 62a, and specifically, is three times or more the plate width dimension of the first connecting portion 62a.

Since the lower edge of the second plate portion 61b is positioned above the lower edge of the first plate portion 61a in the up-down direction, an up-down dimension of the second connecting portion 62b is larger than an up-down dimension of the first connecting portion 62a.

The plurality of connecting portions 62a, 62b, and 62c include a plurality of (four) third connecting portions 62c with the plate thickness direction oriented in the up-down direction.

The third connecting portion 62c is connected to the first plate portion 61a of the fixed shield portion 61 via a curved portion.

Since a plate thickness direction of the third connecting portion 62c is oriented in the up-down direction, a bonding area can be increased as compared with the first connecting portion 62a or the second connecting portion 62b, and an attachment strength of the first shield member 21 can be easily secured.

Positions of the third connecting portion 62c in the front-rear direction are positions corresponding to a front end and a rear end of the first plate portion 61a. This also makes it easy to secure the attachment strength of the first shield member 21.

The fixed shield portion 61 has a plurality of cutout portions 63.

The cutout portion 63 is formed in the first plate portion 61a of the fixed shield portion 61. Specifically, each of the pair of first plate portions 61a has two cutout portions 63.

The cutout portion 63 is a portion in which a part near the lower edge of the fixed shield portion 61 is cut out. A position of the cutout portion 63 is a position corresponding to the position where the first power supply terminal 30B of the first connector 11 is disposed. As a result, an appropriate distance is secured between the fixed shield portion 61 and the first power supply terminal 30B.

The position of the cutout portion 63 is a position adjacent to an inside of the third connecting portion 62c in the front-rear direction.

### (Movable Shield Portion 70)

The movable shield portion 70 has a tubular shape (specifically, a quadrangular tubular shape).

The movable shield portion 70 includes a pair of first plate portions 71a and a pair of second plate portions 71b.

The pair of first plate portions 71a face each other in the width direction. Specifically, each of the first plate portions 71a has a flat plate shape with the plate thickness direction oriented in the width direction.

The pair of second plate portions 71b face each other in the front-rear direction. Specifically, each of the second plate portions 71b has a flat plate shape with the plate thickness direction oriented in the front-rear direction.

The first plate portion 71a of the movable shield portion 70 is positioned on the outer side of the first plate portion 61a of the fixed shield portion 61 in the width direction.

The second plate portion 71b of the movable shield portion 70 is positioned on the outer side of the second plate portion 61b of the fixed shield portion 61 in the front-rear direction.

In a state where the movable shield portion 70 is at an initial position (see FIGS. 6 and 7), a lower end of the movable shield portion 70 is positioned below an upper end of the fixed shield portion 61. This prevents the lower end of the movable shield portion 70 from colliding with the upper end of the fixed shield portion 61 and buckling. A gap in the up-down direction is prevented from being generated between the lower end of the movable shield portion 70 and the upper end of the fixed shield portion 61.

The movable shield portion 70 includes a supported portion 72 supported by the elastic support portion 80.

The supported portion 72 includes a pair of first portions 72a and a pair of second portions 72b. A curved portion is formed between the first portion 72a and the second portion 72b. Thus, the supported portion 72 is formed in a frame shape.

An upper end of the first portion 72a is connected to an upper end of the first plate portion 71a via a curved portion. The first plate portion 71a is formed by bending a portion above the first portion 72a outward in the width direction.

An upper end of the second portion 72b is connected to an upper end of the second plate portion 71b via a curved portion. The second plate portion 71b is formed by bending a portion above the second portion 72b outward in the front-rear direction.

### (Contact Portion 73)

The movable shield portion 70 has a plurality of contact portions 73a and 73b.

Each of the plurality of contact portions 73a and 73b comes into contact with the second substrate 92 as a “connection target”. Specifically, each of the plurality of contact portions 73a and 73b comes into contact with a pad (not illustrated) formed on a lower surface of the second substrate 92. As a result, the first shield member 21 and the second substrate 92 are electrically connected.

The plurality of contact portions 73a and 73b include a plurality of first contact portions 73a protruding from the first portion 72a of the supported portion 72. Therefore, the first contact portion 73a is positioned on the same plane as the first plate portion 61a of the fixed shield portion 61, the elastic support portion 80, and the first portion 72a.

A plurality of (three) first contact portions 73a are formed for each first portion 72a. The first contact portion 73a has a substantially semicircular shape.

The plurality of contact portions 73a and 73b include a plurality of second contact portions 73b protruding from the second portion 72b of the supported portion 72. Therefore, the second contact portion 73b is positioned on the same plane as the first plate portion 61a of the fixed shield portion 61 and the second portion 72b.

A plurality of (two) second contact portions 73b are formed for each of the second portions 72b. The second contact portion 73b has a substantially semicircular shape.

Hereinafter, when the first contact portion 73a and the second contact portion 73b are not distinguished from each other, they are simply referred to as contact portions 73.

Although not illustrated, the pad formed on the lower surface of the second substrate 92 has an area larger than a contact area between the contact portions 73 of the first shield member 21 and the pad.

Therefore, even when the movable shield portion 70 of the first shield member 21 and the second substrate 92 are slightly displaced in the direction in the XY plane, it is possible to realize a state in which they are in contact with each other. In particular, in the present embodiment, the first shield member 21 does not have a structure for the movable shield portion 70 to be displaced in the direction in the XY plane. In such a case, the above configuration is particularly effective.

### (Elastic Support Portion 80)

The at least one elastic support portion 80 includes an elastic support portion 80 on one side in the width direction and an elastic support portion 80 on the other side in the width direction.

The elastic support portion 80 connects the first plate portion 61a of the fixed shield portion 61 and the first portion 72a of the supported portion 72 of the movable shield portion 70.

The elastic support portion 80 is positioned on the same plane as the first plate portion 61a and the first portion 72a.

The elastic support portion 80 includes a pair of spring pieces 81.

The pair of spring pieces 81 have a symmetrical shape in the front-rear direction.

Each spring piece 81 has a lower portion 81a extending in an upward direction and an oblique direction on the outer side in the front-rear direction, an upper portion 81b extending in the upward direction and an oblique direction on an inner side in the front-rear direction, and a middle portion 81c connecting the lower portion 81a and the upper portion 81b.

The lower portion 81a and the upper portion 81b extend linearly. The middle portion 81c extends in a substantially arc shape.

At a base end portion 80a of the elastic support portion 80, one spring piece 81 and the other spring piece 81 are integrated.

At a distal end portion 80b of the elastic support portion 80, one spring piece 81 and the other spring piece 81 are integrated.

As a result, concentration of stress on the base end portion 80a or the distal end portion 80b of the elastic support portion 80 is suppressed.

The first shield member 21 is made of a conductive material. Specifically, the first shield member 21 is made of one conductive plate.

The first shield member 21 has a tubular shape (specifically, a quadrangular tubular shape) as a whole by the fixed shield portion 61 and the movable shield portion 70.

As illustrated in FIG. 6, a joint portion 21h in which end portions of plate materials constituting the first shield member 21 are joined to each other is formed at a position corresponding to one second plate portion 61b of the pair of second plate portions 61b of the fixed shield portion 61 and one second plate portion 71b of the pair of second plate portions 71b of the movable shield portion 70.

FIG. 3 illustrates a state in which the first connector 11 and the second connector 12 are connected.

However, in the state illustrated in FIG. 3, the contact portion 32 of the first terminal 30 of the first connector 11 and the contact portion 52 of the second terminal 50 of the second connector 12 are in contact with each other, and the plurality of contact portions 73a and 73b of the movable shield portion 70 are in contact with the second substrate 92, but the movable shield portion 70 does not displace from the initial position.

Although the first connector 11 and the second connector 12 are normally connected even in the state illustrated in FIG. 3, the first connector 11 and the second connector 12 can be connected more deeply. That is, even when a distance between the first substrate 91 and the second substrate 92 is smaller than a distance illustrated in FIG. 3, the connection state between the first connector 11 and the second connector 12 is kept normal. That is, the first connector 11 and the second connector 12 are configured to be normally connected even when the distance between the first substrate 91 and the second substrate 92 is somewhat wide.

Although not illustrated, when the distance between the first substrate 91 and the second substrate 92 is smaller than the distance illustrated in FIG. 3, the movable shield portion 70 is pressed downward by the second substrate 92 at the plurality of contact portions 73a and 73b, and is elastically displaced downward from the initial position.

### Operation and Effect

Next, operations and effects of the present embodiment will be described.

In the present embodiment, the shield member 21 includes the base portion 60 that does not displace with respect to the attachment target 91 and the movable shield portion 70 that is displaceable with respect to the base portion 60.

Therefore, the shielding target (pair of connectors 11 and 12) can be shielded by the movable shield portion 70 that is displaceable with respect to the attachment target 91.

In the present embodiment, the movable shield portion 70 has the contact portion 73 configured to come into contact with the contact target 92 as a result of bringing the contact target 92 and the shield member 21 close to each other in the first direction. The contact portion 73 of the movable shield portion 70 is configured such that a contact pressure is generated in the first direction (Z direction) by the contact with the contact target 92. The movable shield portion 70 is configured to be displaced in the first direction (Z direction) when the contact portion 73 is pressed by the contact target 92 in the first direction (Z direction).

Therefore, it is possible to suppress generation of a gap in the first direction between the contact target 92 and the shield member 21 or increase of the gap due to variation in a distance in the first direction between the attachment targets 91 and 92 and the contact target 92.

Here, it is assumed that the contact portion 73 of the movable shield portion 70 is configured such that a contact pressure is generated in a direction in a plane perpendicular to the first direction by the contact with the contact target 92. In this case, when the position of the contact target 92 with respect to the movable shield portion 70 deviates from a predetermined position in the direction in the plane, there is a possibility that an appropriate contact pressure cannot be obtained.

Therefore, in the present embodiment, the contact portion 73 of the movable shield portion 70 is configured such that a contact pressure is generated in the first direction by the contact with the contact target 92.

Therefore, even when the position of the contact target 92 with respect to the movable shield portion 70 deviates from a predetermined position in the direction in the plane perpendicular to the first direction, it is easy to obtain an appropriate contact pressure.

In the present embodiment, the contact portion 73 of the movable shield portion 70 is formed in a convex shape so as to come into point contact with the contact target 92.

Therefore, it is compatible with a planar contact portion (pad not illustrated) of the contact target 92.

In the present embodiment, the movable shield portion 70 does not have a portion that is fixed to the shielding target (pair of connectors 11 and 12).

Therefore, it is not necessary to provide a structure for being fixed to the shielding target (pair of connectors 11 and 12) on the movable shield portion 70. As a result, the structure of the shield member 21 can be simplified.

In particular, in the present embodiment, the movable shield portion 70 does not have a portion that is physically engaged with the shielding target (pair of connectors 11 and 12).

Therefore, it is not necessary to provide a structure for physically engaging with the shielding target (pair of connectors 11 and 12) on the movable shield portion 70. As a result, the structure of the shield member 21 can be simplified.

Furthermore, in the present embodiment, the shield member 21 does not have a portion that is fixed to the shielding target (pair of connectors 11 and 12).

Therefore, it is not necessary to provide a structure for being fixed to the shielding target (pair of connectors 11 and 12) on the shield member 21. As a result, the structure of the shield member 21 can be simplified.

In a case in which the movable shield portion 70 and the like do not have a portion that is fixed to the shielding target, it is needless to say that it is unnecessary to provide a structure for fixing the movable shield portion 70 and the like on the shielding target. As a result, the structure of the shielding target can be simplified.

In the present embodiment, the base portion 60 includes the fixed shield portion 61 that shields the shielding target (pair of connectors 11 and 12).

Therefore, the shielding target (pair of connectors 11 and 12) can be shielded by both the fixed shield portion 61 that does not displace with respect to the attachment target 91 and the movable shield portion 70 that is displaceable with respect to the attachment target 91.

In the present embodiment, the fixed shield portion 61 has a tubular shape, and the movable shield portion 70 has a tubular shape.

Therefore, high shielding performance can be exhibited.

Furthermore, in the present embodiment, a part of the fixed shield portion 61 is disposed inside the movable shield portion 70. That is, it can be said that a part of one of the fixed shield portion 61 and the movable shield portion 70 is disposed inside the other.

Therefore, it is possible to suppress generation of a gap (gap in the up-down direction) between the tubular fixed shield portion and the tubular movable shield portion.

In the present embodiment, as illustrated in FIG. 6, the elastic support portion 80 is formed on the inner side of the shield 21 with respect to the movable shield portion 70.

Therefore, it is possible to prevent the elastic support portion 80 from being damaged or the like due to contact from the outside.

It is assumed that the contact portion 32 of the terminal 30 of the connector 11 is configured such that a contact pressure is generated in the first direction (Z direction) by the contact with the terminal 50 of the mating connector 12. In this case, in order to secure stable electrical connection, it is necessary to continuously press the connector 11 and the mating connector 12 strongly in the first direction, and both substrates (the substrate 91 and the mating substrate 92) are easily bent together with the pressing of the movable shield portion 70 and the contact target 92 in the first direction (Z direction).

Therefore, in the present embodiment, the contact portion 32 of the terminal 30 of the connector 11 is configured such that a contact pressure is generated in a direction in a plane perpendicular to the first direction by the contact with the terminal 50 of the mating connector 12.

Therefore, it is possible to suppress bending of both substrates (the substrate 91 and the mating substrate 92).

### Second Embodiment

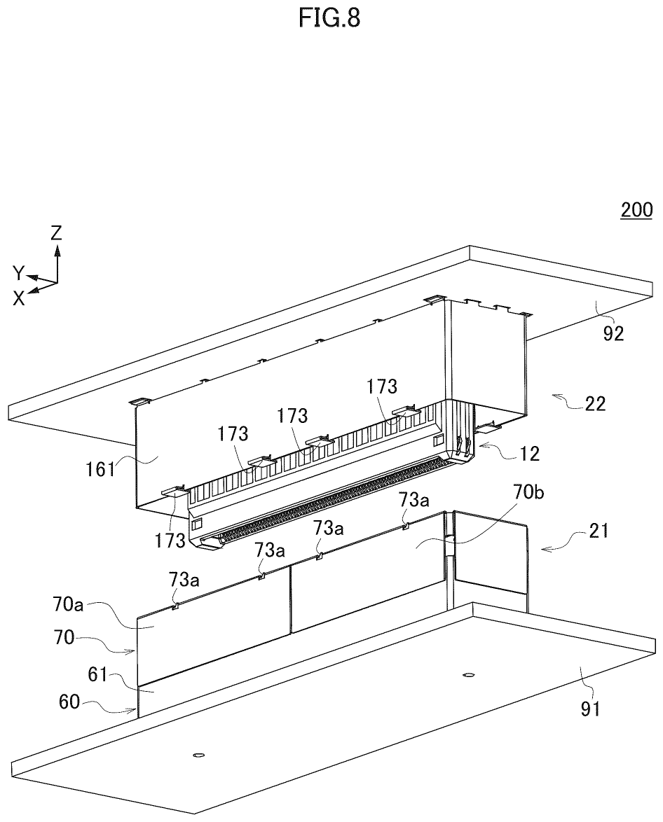

FIGS. 8 to 11 illustrate a shield structure 200 and the like according to a second embodiment.

In the shield structure 200 according to the second embodiment, unlike the shield structure 100 according to the first embodiment, shields 21 and 22 include a second shield member 22 attached to the second substrate 92 in addition to the first shield member 21 attached to the first substrate 91. The first shield member 21 of the second embodiment shields the pair of connectors 11 and 12 in cooperation with the second shield member 22. Therefore, in the second embodiment, an target (contact target) with which the first shield member 21 comes into contact is the second shield member 22.

In the second embodiment, the second connector 12 is a floating connector, and the first connector 11 is a connector that is not a floating connector. However, as in the first embodiment, the first connector 11 may be a floating connector, and the second connector 12 may be a connector that is not a floating connector.

The first shield member 21 of the second embodiment has a configuration similar to that of the first shield member 21 of the first embodiment. Hereinafter, in the configuration of the first shield member 21 of the second embodiment, differences from the first shield member 21 of the first embodiment will be mainly described.

### (Restriction Mechanisms 65 and 75)

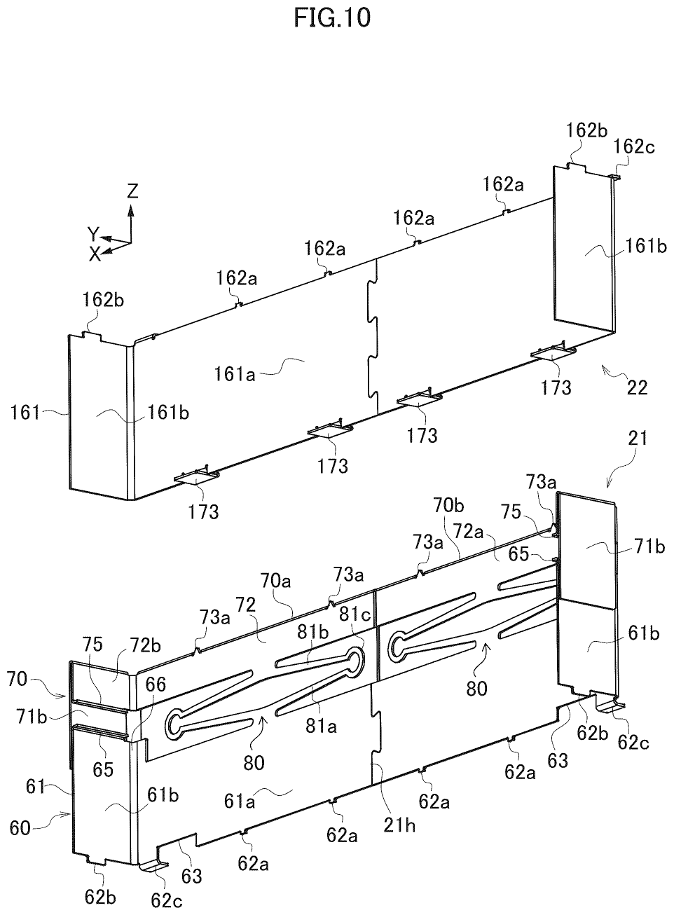

As illustrated in FIG. 10, the first shield member 21 includes restriction mechanisms 65 and 75 that restrict excessive displacement of the movable shield portion 70 in a direction (−Z direction) approaching the first attachment target 91 (attachment target).

The restriction mechanisms 65 and 75 are configured to restrict excessive displacement by a part and another part of the first shield member 21 abutting on each other. That is, the restriction mechanisms 65 and 75 are completed in the first shield member 21.

The specific structures of the restriction mechanisms 65 and 75 are as follows.

The restriction mechanisms 65 and 75 include an abutted portion 65 of the base portion 60 and an abutting portion 75 of the movable shield portion 70. When the movable shield portion 70 moves in a direction approaching the first attachment target 91 (−Z direction), the abutting portion 75 of the movable shield portion 70 abuts on the abutted portion 65 of the base portion 60.

The abutting portion 75 is formed at a lower end of each of the pair of second portions 72b of the supported portion 72 of the movable shield portion 70.

The abutted portion 65 is formed at an upper end of each of the pair of second plate portions 61b of the fixed shield portion 61.

The abutted portion 65 is formed above a portion of the fixed shield portion 61 connected to the elastic support portion 80 (upper edge of the first plate portion 61a). As a result, a distance (distance in the up-down direction) between the abutting portion 75 and the abutted portion 65 is smaller than an up-down dimension of the elastic support portion 80.

The abutting portion 75 is formed by bending a lower portion of the second portion 72b toward the inside of the shield 21 (inside in the front-rear direction).

The abutted portion 65 is formed by bending an upper portion of the second plate portion 61b toward the inside of the shield 21 (inside in the front-rear direction).

Accordingly, not plate end surfaces but plate surfaces are brought into contact with each other. As a result, excessive displacement of the movable shield portion 70 can be restricted more reliably.

### (Extension Portion 66)

The fixed shield portion 61 has an extension portion 66 for closing a gap between the first plate portion 71a and the second plate portion 71b of the movable shield portion 70.

The extension portion 66 is a portion of the fixed shield portion 61 near the curved portion connecting the first plate portion 61a and the second plate portion 61b, and is a portion above the upper edge of the first plate portion 61a. It can be said that the extension portion 66 is a portion in which a part of the fixed shield portion 61 is extended in the upward direction.

(First Portion 70a and Second Portion 70b that are Displaceable Independently of Each Other)

The movable shield portion 70 of the first shield member 21 includes a first portion 70a and a second portion 70b that are displaceable independently of each other. Therefore, even when the contact target 92 is inclined with respect to a predetermined state, a favorable contact state between the movable shield portion 70 and the contact target 92 can be realized.

The first portion 70a constitutes one side of the movable shield portion 70 in the front-rear direction.

The second portion 70b constitutes the other side of the movable shield portion 70 in the front-rear direction.

The first portion 70a and the second portion 70b have substantially the same structure.

The first shield member 21 is formed by subjecting one plate material to punching, bending, or the like. In the first shield member 21, one part and the other part are connected as a plate. This point is similar to the first shield member 21 of the first embodiment.

In this regard, in the first shield member 21 of the second embodiment, the joint portion 21h where end portions of the plate material as the material are joined to each other is positioned not in the second plate portion 61b of the fixed shield portion 61 but in the first plate portion 61a of the fixed shield portion 61.

As illustrated in FIG. 10, a pair of elastic support portions 80 are formed for each of the first portion 70a and the second portion 70b. That is, the first shield member 21 includes a total of four elastic support portions 80.

The second embodiment is similar to the first embodiment in that the middle portion 81c of the spring piece 81 extends in a substantially arc shape. However, as illustrated in FIG. 10, the substantially arc-shaped middle portion 81c of the second embodiment is an arc having an angle of 180 degrees or more unlike the first embodiment. Therefore, stress concentration in the middle portion 81c can be suppressed.

In the first shield member 21 of the second embodiment, the movable shield portion 70 has the plurality of first contact portions 73a, but does not have the second contact portion (see reference numeral 73b in FIG. 6).

### (Second Shield Member 22)

The second shield member 22 includes a fixed shield portion 161 and does not include a movable shield portion.

The fixed shield portion 161 has a tubular shape (specifically, a quadrangular tubular shape).

The fixed shield portion 161 includes a pair of first plate portions 161a and a pair of second plate portions 161b.

The pair of first plate portions 161a face each other in the width direction. Specifically, each of the first plate portions 161a has a flat plate shape with the plate thickness direction oriented in the width direction.

The pair of second plate portions 161b face each other in the front-rear direction. Specifically, each of the second plate portions 161b has a flat plate shape with the plate thickness direction oriented in the front-rear direction.

The second shield member 22 includes a plurality of connecting portions 162a, 162b, and 162c.

Each of the plurality of connecting portions 162a, 162b, and 162c is bonded to a pad (not illustrated) formed on an upper surface of the first substrate 91 by soldering.

The plurality of connecting portions 162a, 162b, and 162c include a plurality of first connecting portions 162a protruding from the first plate portion 161a.

The plurality of connecting portions 162a, 162b, and 162c include a plurality of second connecting portions 162b protruding from the second plate portion 161b.

The plurality of connecting portions 162a, 162b, and 162c include a plurality of (four) third connecting portions 162c with the plate thickness direction oriented in the up-down direction. The third connecting portion 162c is connected to the first plate portion 161a of the fixed shield portion 161 via a curved portion.

The second shield member 22 includes a plurality of contact portions 173 that come into contact with each of the plurality of contact portions 73 of the first shield member 21.

The contact portion 173 of the second shield member 22 has a flat plate shape. The contact portion 173 is a planar plate surface and comes into contact with the contact portion 73 of the first shield member 21. Since the plate surface is a contact portion, plating is easily applied to the contact portion.

The plate surface of the contact portion 173 has an area larger than a contact area between the contact portion 73 of the first shield member 21 and the contact portion 173 of the second shield member 22.

Therefore, even when the movable shield portion 70 of the first shield member 21 and the second shield member 22 are slightly displaced in the direction in the XY plane, it is possible to realize a state in which they are in contact with each other. In particular, in the present embodiment, the first shield member 21 does not have a structure for the movable shield portion 70 to be displaced in the direction in the XY plane. In such a case, the above configuration is particularly effective.

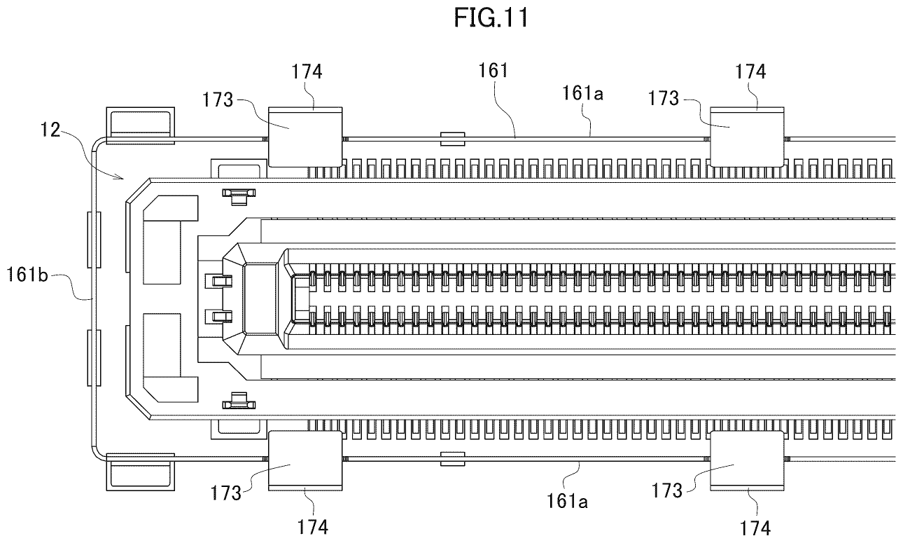

When viewed from below, the contact portion 173 overlaps a pad for the second signal terminal 50A formed on the lower surface of the second substrate 92 (see FIG. 11). In other words, an orthogonal projection of the contact portion 173 onto the lower surface of the second substrate 92 overlaps the pad for the second signal terminal 50A formed on the lower surface of the second substrate 92. Therefore, the contact portion 173 can be formed large.

A curved portion 174 is formed on the outer side of the contact portion 173 of the second shield member 22 in the width direction. The contact portion 173 is connected to the first plate portion 161a of the fixed shield portion 161 of the second shield member 22 via the curved portion 174. The contact portion 173 extends inward in the width direction from the curved portion 174. As a result, as illustrated in FIG. 11, the contact portion 173 is formed in a range extending over the inside and the outside of the tubular fixed shield portion 161.

Instead of the above configuration, the curved portion 174 may be formed on the inner side in the width direction of the contact portion 173 of the second shield member 22. In this case, the contact portion 173 extends outward in the width direction from the curved portion 174.

The contact portion 173 having a flat plate shape is not formed at a position corresponding to the second plate portion 161b in the second shield member 22 having a quadrangular tubular shape. Therefore, it is not necessary to form the contact portion 173 of the second shield member 22 so as to protrude outward in the front-rear direction of the second plate portion 161b.

Therefore, it is possible to suppress an increase in a front-rear dimension of the second shield member 22.

In the present embodiment, the shield member 21 includes the base portion 60 that does not displace with respect to the attachment target 91 and the movable shield portion 70 that is displaceable with respect to the base portion 60.

Therefore, the shielding target (pair of connectors 11 and 12) can be shielded by the movable shield portion 70 that is displaceable with respect to the attachment target 91.

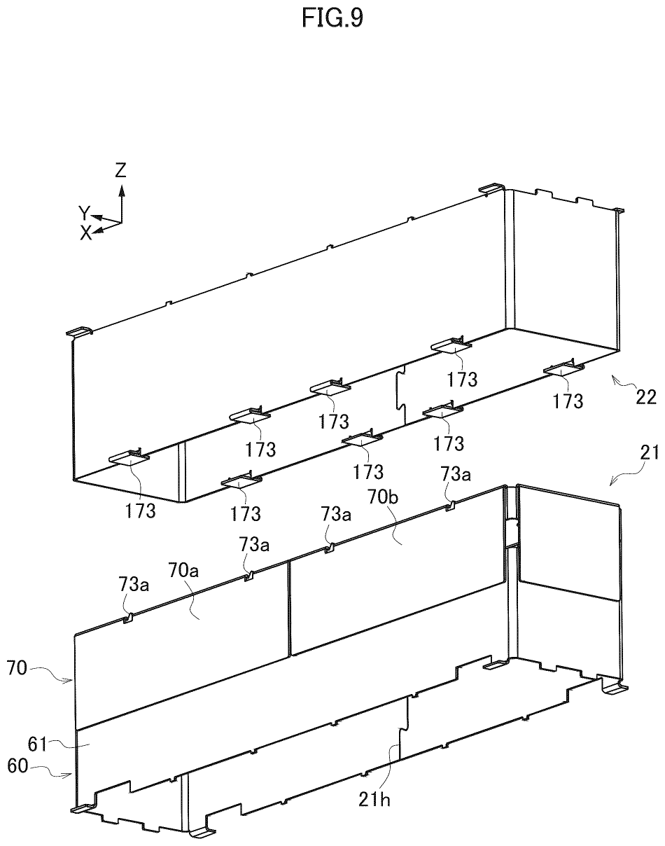

In the present embodiment, as illustrated in FIG. 9, the movable shield portion 70 has the contact portion 73 configured to come into contact with the contact target 22 as a result of bringing the contact target 22 (second shield member 22) and the shield member 21 close to each other in the first direction. The contact portion 73 of the movable shield portion 70 is configured such that a contact pressure is generated in the first direction (Z direction) by the contact with the contact target 22. The movable shield portion 70 is configured to be displaced in the first direction (Z direction) when the contact portion 73 is pressed by the contact target 22 in the first direction (Z direction).

Therefore, it is possible to suppress generation of a gap in the first direction between the contact target 22 and the shield member 21 or increase of the gap due to variation in a distance in the first direction between the attachment targets 91 and 92 and the contact target 22.

Meanwhile, in the first embodiment, the shield 21 includes only the first shield member 21. That is, the first shield member 21 shields the entire pair of connectors 11 and 12 (see FIG. 3). Therefore, as illustrated in FIG. 2, an upper end of the first connector 11 is positioned below the upper end of the first shield member 21, and the distance in the up-down direction between the upper end of the first connector 11 and the upper end of the first shield member 21 increases. In this case, it is likely to be difficult to detach a cap 16 mounted on the first connector 11. The cap 16 is a member having a suction surface 16a for sucking the connector when the connector is moved and disposed on the substrate.

Therefore, in the present embodiment, the first shield member 21 shields the pair of connectors 11 and 12 in cooperation with the second shield member 22.

Therefore, the upper end of the first shield member 21 is easily positioned above the upper end of the first shield member 21, and even when the upper end of the first connector 11 is positioned below the upper end of the first shield member 21, the distance in the up-down direction between the upper end of the first connector 11 and the upper end of the first shield member 21 becomes small. As a result, the work of detaching the cap 16 mounted on the first connector 11 is facilitated.

From the viewpoint of facilitating the work, the suction surface 16a of the cap 16 is preferably positioned above the upper end of the first shield member 21.

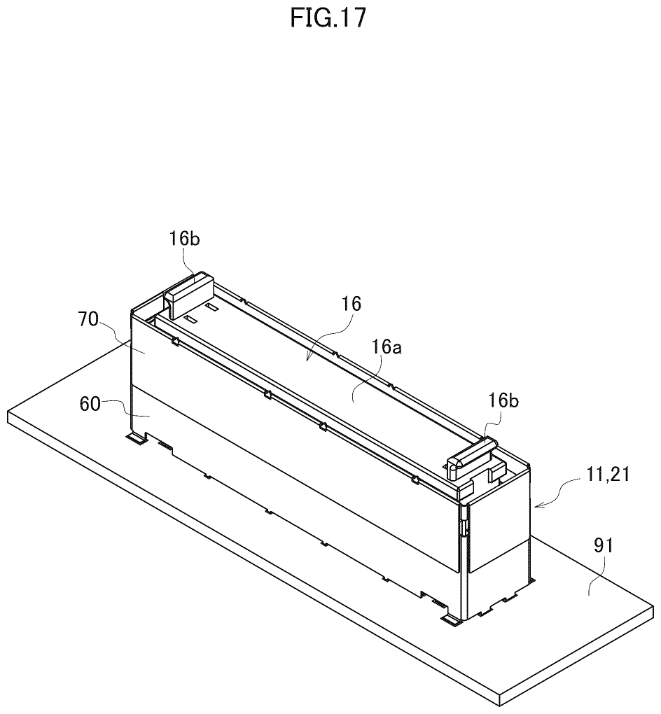

Here, the cap 16 that further facilitates the work of detaching the cap will be described with reference to FIG. 17.

FIG. 17 illustrates the connectors 11 and 21 with a shield member in a state where the cap 16 is mounted.

The cap 16 has a planar suction surface 16a and at least one operation portion 16b.

Specifically, the at least one operation portion 16b includes a pair of operation portions 16b. The pair of operation portions 16b are provided on one side and the other side in the front-rear direction with respect to the suction surface 16a.

Each operation portion 16b has a shape protruding upward with respect to the suction surface 16a. Each operation portion 16b has a shape capable of hooking a jig or the like from the outside in the front-rear direction.

### (Modifications)

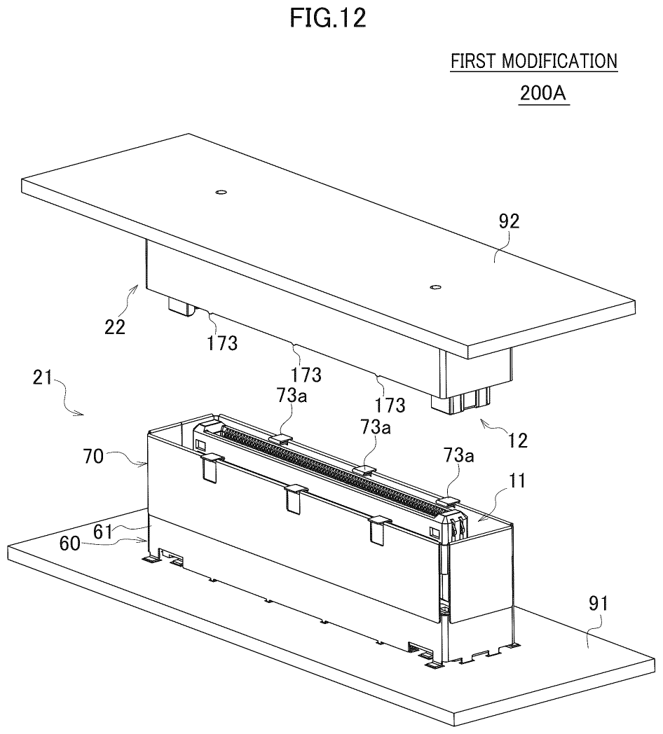

FIG. 12 illustrates a shield structure 200A according to a first modification.

In the second embodiment, the contact portion 73 of the first shield member 21 is a contact portion having a convex shape, and the contact portion 173 of the second shield member 22 is a contact portion having a flat plate shape (see FIG. 10).

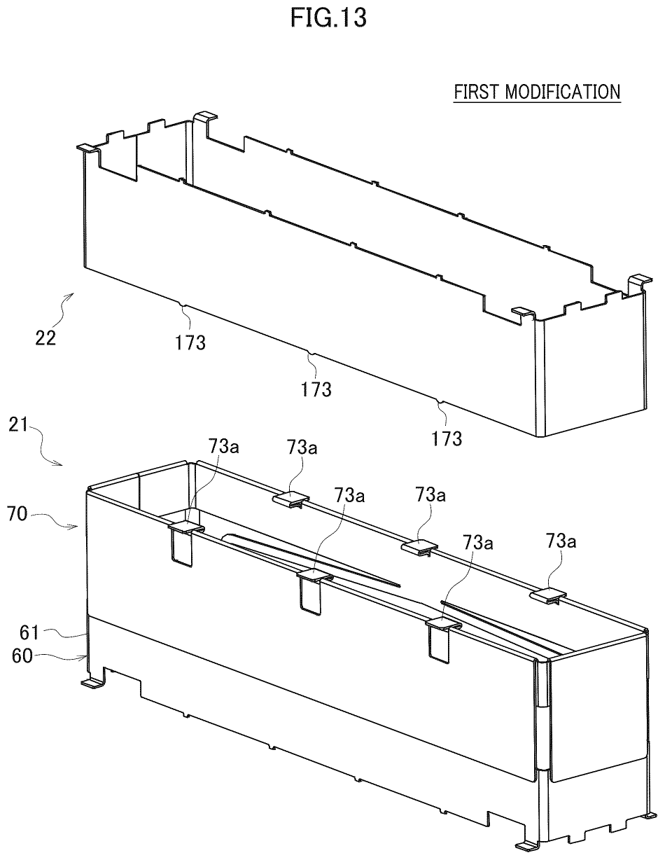

On the other hand, in the first modification, as illustrated in FIGS. 12 and 13, the contact portion 73 of the first shield member 21 is a contact portion having a flat plate shape, and the contact portion 173 of the second shield member 22 is a contact portion having a convex shape. Even in this case, even when the movable shield portion 70 of the first shield member 21 and the second shield member 22 are slightly displaced in the direction in the XY plane, it is possible to realize a state in which they are in contact with each other.

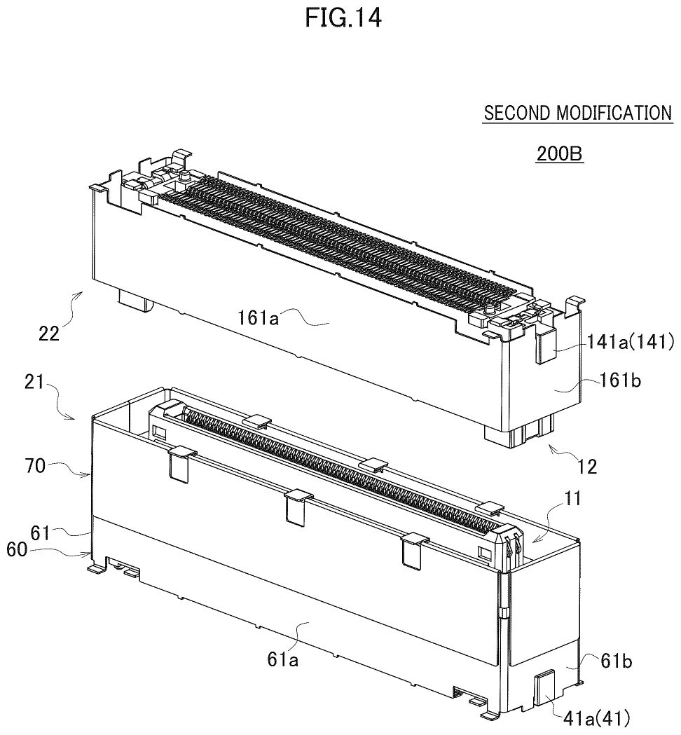

FIG. 14 illustrates a shield structure 200B according to a second modification. However, in FIG. 14, the attachment targets 91 and 92 are omitted.

In the second modification, the base portion 60 of the first shield member 21 is fixed to the first connector 11. That is, the base portion 60 of the first shield member 21 has a portion (second plate portion 61b) that is fixed to the shielding target (first connector 11).

Therefore, the shielding target (first connector 11) and the first shield member 21 can be handled integrally.

In the second modification, the second shield member 22 is fixed to the second connector 12. That is, the second shield member 22 has a portion that is fixed to the shielding target (second connector 12).

As illustrated in FIG. 14, the first shield member 21 is fixed to the first connector 11 at positions of both ends in the front-rear direction. Specifically, the pair of second plate portions 61b of the fixed shield portion 61 of the first shield member 21 are fixed to the fixed housing 41 of the first connector 11.

Specifically, the fixed housing 41 has a pair of fixing portions 41a for fixing the first shield member 21, and the first shield member 21 has a pair of second plate portions 61b as fixed portions for being fixed to the fixed housing 41.

As illustrated in FIG. 14, the second shield member 22 is fixed to the second connector 12 at positions of both ends in the front-rear direction. Specifically, the pair of second plate portions 161b of the fixed shield portion 161 of the second shield member 22 are fixed to the fixed housing 141 of the second connector 12.

Specifically, the fixed housing 141 has a pair of fixing portions 141a for fixing the second shield member 22, and the second shield member 22 has a pair of second plate portions 161b as fixed portions for being fixed to the fixed housing 141.

### [Commonality of Shields]

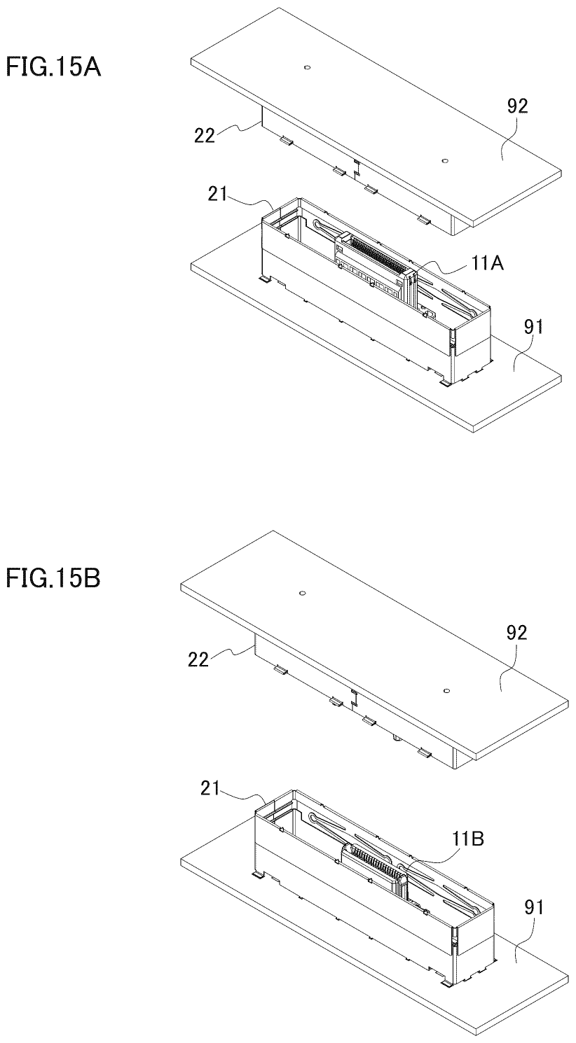

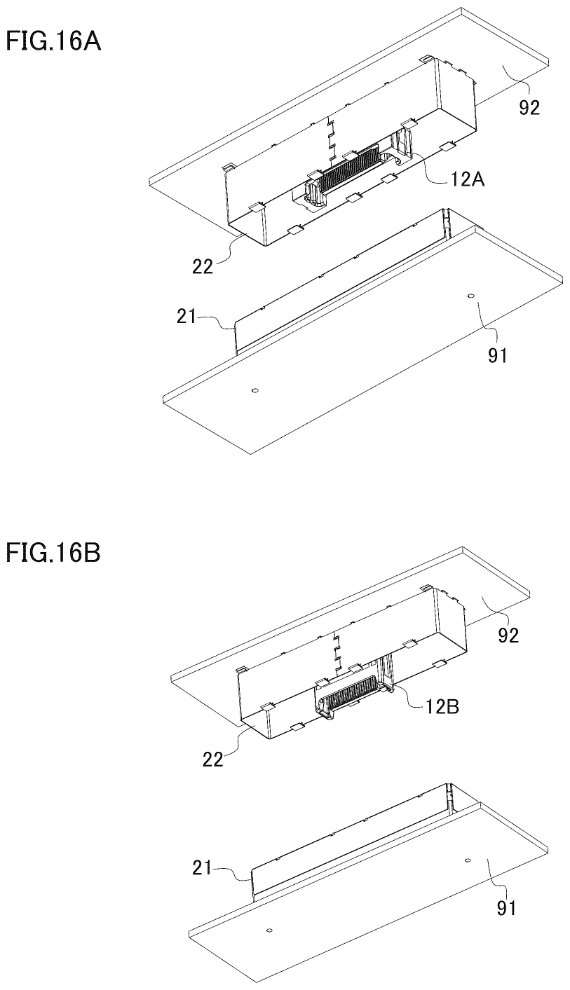

Next, commonality of the shields will be described with reference to FIGS. 15A to 16B.

FIGS. 15A and 16A both illustrate a shield structure A.

FIGS. 15B and 16B both illustrate a shield structure B.

Both the shield structure A and the shield structure B include common shields 21 and 22. On the other hand, the shield structure A includes a pair of connectors 11A and 12A, and the shield structure B includes a pair of connectors 11B and 12B different in type from the pair of connectors 11A and 12A.

That is, in the shield structure A and the shield structure B, the same shields 21 and 22 are used although the types (shapes and the like) of the pair of connectors 11 and 12 as shielding targets are different.

In particular, the first shield member 21 and the second shield member 22 constituting the shields 21 and 22 illustrated in FIGS. 15A to 16B do not have a portion that is fixed to the pair of connectors 11 and 12. Further, the first shield member 21 and the second shield member 22 do not have a portion that is physically engaged with the pair of connectors 11 and 12. For this reason, it is less necessary to provide a structure corresponding to the structure of the pair of connectors 11 and 12 in the shields 21 and 22. As a result, commonality of the shields is facilitated.

However, the commonality of the shields is possible even in a case in which the shield member constituting the shield has a portion that is fixed to the shielding target.

For example, in a third embodiment (see FIG. 14), the first shield member 21 is fixed to the fixed housing 41 of the first connector 11, and the second shield member 22 is fixed to the fixed housing 141 of the second connector 12. Even with such a structure, when the fixing portions 41a and 141a have a common structure between different types of the pair of connectors, the shields 21 and 22 can be used in common.

However, like the first shield member 21 described so far, the shield member in which the movable shield portion 70 does not have a portion that is fixed to the shielding target can be said to facilitate commonality of the shield member among the plurality of types of connectors.

The above-described commonality of the shields is also possible in a case in which the shield is formed of only the first shield member (see the first embodiment).

By making the shield common among the plurality of types of the pair of connectors or making the shield member common among the plurality of types of connectors, the cost of designing the shield member, the cost of providing manufacturing equipment for manufacturing the shield member, and the like can be greatly reduced. As a result, an inexpensive shield member, a connector with a shield member, and the like can be realized.

### Supplementary Description of Embodiments

Although the preferred embodiments of the connector of the disclosure have been described above, the disclosure is not limited thereto. The following description is a supplementary description just in case.

In the embodiments, the electronic component as the shielding target is a pair of connectors, but the electronic component as the shielding target of the disclosure is not limited thereto.

In the embodiments, the cap 16 includes at least one operation portion 16b, but the cap of the disclosure is not limited thereto, and not necessarily includes an operation portion. In this case, it is preferable that the suction surface of the cap is located above the upper end of the shield member in a state where the cap is mounted.

In the embodiments, the cap 16 includes at least one operation portion 16b, and at least a part of the operation portion 16b is located above the upper end of the shield member (see FIG. 17). Therefore, the work of detaching the cap 16 is facilitated. However, the disclosure is not limited thereto, and the entire operation portion 16b may be located below the upper end of the shield member.

In the example illustrated in FIG. 17, the suction surface 16a of the cap is located below the upper end of the shield member 21. However, even when the cap includes the operation portion, the suction surface of the cap may be located above the upper end of the shield member.

### DESCRIPTION OF REFERENCE NUMERALS

11 First connector (connector, electronic component, shielding target)
12 Second connector (mating connector, electronic component, shielding target)
21 First shield member (shield member, shield)
21h Joint portion
22 Second shield member (shield member, shield)
30 First terminal (terminal)
30A First signal terminal
30B First power supply terminal
31 Connecting portion
32 Contact portion
41 Fixed housing (housing)
42 Movable housing (housing)
50 Second terminal
50A Second signal terminal
50B Second power supply terminal
52 Contact portion
60 Base portion
61 Fixed shield portion
61a First plate portion
61b Second plate portion
62a First connecting portion (connecting portion)
62b Second connecting portion (connecting portion)
62c Third connecting portion (connecting portion)
65 Abutted portion (restriction mechanism)
70 Movable shield portion
70a First portion
70b Second portion
73a First contact portion (contact portion)
73b Second contact portion (contact portion)
75 Abutting portion (restriction mechanism)
80 Elastic support portion
81 Spring piece
91 First substrate (substrate, first attachment target, attachment target)
92 Second substrate (contact target, second attachment target, mating substrate)
100 Shield structure
161 Fixed shield portion
173 Contact portion

What is claimed is:

1. A shield member for shielding a shielding target, the shield member comprising:
a base portion that does not displace with respect to an attachment target; and
a movable shield portion that is displaceable with respect to the base portion,
wherein the movable shield portion does not have a portion that is fixed to the shielding target.

2. The shield member according to claim 1, wherein the movable shield portion does not have a portion that is physically engaged with the shielding target.

3. The shield member according to claim 1, wherein the base portion does not have a portion that is fixed to the shielding target.

4. The shield member according to claim 1, wherein the shield member does not have a portion that is fixed to the shielding target.

5. The shield member according to claim 1, wherein the base portion has a portion that is fixed to the shielding target.

6. The shield member according to claim 1, wherein the base portion includes a fixed shield portion that shields the shielding target.

7. The shield member according to claim 6, wherein:
the fixed shield portion has a tubular shape, and
the movable shield portion has a tubular shape.

8. The shield member according to claim 7, wherein a part of either one of the fixed shield portion or the movable shield portion is disposed inside the other.

9. A connector with a shield member that is attachable to an attachment target, which is a substrate, and that is connectable to a mating connector in a first direction, the connector with a shield member comprising:
a shielding target, which is a connector, and a shield member, wherein:
the connector includes a movable housing that is displaceable with respect to the attachment target,
the shield member includes:
a base portion that does not displace with respect to the attachment target; and
a movable shield portion that is displaceable with respect to the base portion, and
the movable shield portion does not have a portion that is fixed to the shielding target.

10. The connector with a shield member according to claim 9, wherein the movable shield portion does not have a portion that is physically engaged with the shielding target.

11. The connector with a shield member according to claim 9, wherein the base portion has a portion that is fixed to the shielding target.
